(19) United States
(12) Patent Application Publication
(10) Pub. No.: US 2017/0014299 A1
(43) Pub. Date: Jan. 19, 2017

(54) VIBRATORY SALIVA STIMULATOR

(71) Applicant: L'Oreal, Paris (FR)

(72) Inventors: Zane Bowman Allen Miller, Seattle, WA (US); Aaron David Poole, Federal Way, WA (US); Gerald Keith Brewer, Redmond, WA (US); Katherine Ortblad, Seattle, WA (US)

(73) Assignee: L'OREAL, Paris (FR)

(21) Appl. No.: 14/798,211

(22) Filed: Jul. 13, 2015

(51) Int. Cl. A61H 23/02

(52) U.S. Cl. CPC A61H 23/02; A61H 2201/5058

(57) ABSTRACT

A device for stimulating saliva production in a subject includes a source of vibratory motion and a saliva stimulation assembly configured to elicit a salivary response by delivery of a vibratory stimulus. The saliva stimulation assembly includes one or more contact points coupled to the source of vibratory motion and configured to be placed against one or more stimulation sites on one or more portions of skin of the subject. The source of vibratory motion is configured such that, when the source of vibratory motion is operating and the one or more contact points are placed against the stimulation site, the one or more contact points vibrate at a stimulation frequency that produces a stimulus transmitted via the at least one portion of skin to the one or more salivary glands to stimulate saliva production by the one or more salivary glands.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a device for stimulating saliva production in a subject includes a source of vibratory motion and a saliva stimulation assembly. The saliva stimulation assembly is configured to elicit a salivary response by delivery of a vibratory stimulus. The saliva stimulation assembly includes one or more contact points coupled to the source of vibratory motion and is configured to be placed against one or more stimulation sites on one or more portions of skin of the subject corresponding to one or more salivary glands of the subject. The source of vibratory motion is configured such that, when the source of vibratory motion is operating, the one or more contact points vibrate at a stimulation frequency. When the source of vibratory motion is operating and the one or more contact points are placed against the stimulation site, the vibration of the one or more contact points at the stimulation frequency produces a stimulus that is transmitted via the at least one portion of skin of the subject to the one or more salivary glands of the subject to stimulate saliva production by the one or more salivary glands of the subject.

In one example, the device further includes a collar configured to hold the one or more contact points against the one or more portions of skin of the subject corresponding to the one or more salivary glands of the subject. In another example, the collar is adjustable such that a position of the one or more contact points is adjustable based on a location of the one or more salivary glands of the subject. In another example, the collar is configured to hold the one or more contact points against the one or more portions of skin of the subject corresponding to one or more of a right submandibular gland of the subject, a left submandibular gland of the subject, a right parotid gland of the subject, or a left parotid gland of the subject.

In another example, the device further includes a controller configured to control operation of the source of vibratory motion. In another example, the controller is configured to control operation of the source of vibratory motion based on a sensed level of moisture within the mouth of the subject. In another example, the controller is configured to control operation of the source of vibratory motion by disengaging the source of vibratory motion after a predetermined amount of time of continuous operation of the source of vibratory motion. In another example, the stimulation frequency is in a range from about 70 Hz to about 80 Hz. In another example, the one or more contact points include three or fewer contact points.

In another embodiment, a system for stimulating saliva production in a subject includes an appliance having a source of vibratory motion and an end effector operably coupled to the appliance. The end effector is configured to be placed against one or more stimulation sites on one or more portions of skin of the subject corresponding to one or more salivary glands of the subject. The source of vibratory motion is configured to move the end effector such that, when the source of vibratory motion is operating, the system has a stimulation frequency. The system is configured such that, when the source of vibratory motion is operating and the end effector is placed against the one or more stimulation sites, the stimulation frequency is configured to produce a stimulus that is transmitted via the at least one portion of skin of the subject to the one or more salivary glands of the subject to stimulate saliva production by the one or more salivary glands of the subject.

In one example, the system further includes a sensor device configured to be held within a mouth of the subject, where the sensor device includes one or more moisture sensors configured to generate a signal indicative of moisture within the mouth of the subject. In another example, the sensor device is in the form of a mouth guard. In another example, the sensor device further includes a wireless transmitter configured to transmit, to a wireless receiver coupled to the source of vibratory motion, the signal indicative of moisture within the mouth of the subject. In another example, the system is configured to adjust operation of the source of vibratory motion based on the signal indicative of moisture within the mouth of the subject. In another example, the stimulation site is located under the chin of the subject and behind the jaw of the user. In another example, the one or more salivary glands of the subject comprise one or more of a right submandibular gland of the subject, a left submandibular gland of the subject, a right parotid gland of the subject, or a left parotid gland of the subject. In another example, the end effector is removably coupled to the appliance.

In another embodiment, a method of stimulating saliva production in a subject includes delivering a vibratory stimulus to one or more stimulation sites associated with one or more salivary glands of a subject via one or more contact points and varying an average power of an electro-mechanical vibratory motion assembly coupled to the one or more contact points such that the one or more contact points vibrate at a stimulation frequency of a character and for a duration sufficient to elicit a salivary response by delivery of a vibratory stimulus.

In one example, when the one or more contact points are placed against one or more stimulation sites and a source of vibratory motion is activated to produce the vibratory stimulus, the vibration of the one or more contact points at the stimulation frequency produces a stimulus that is transmitted via at least one portion of skin of the subject to the one or more salivary glands of the subject to elicit the salivary response. In another example, delivering the vibratory stimulus to the one or more stimulation sites includes placing a collar that includes the one or more contact points around a neck of the subject. In another example, the method further includes sensing a level of moisture within a mouth of the subject. In another example, the method further includes controlling operation of the source of vibratory motion based on the sensed level of moisture within the mouth of the subject.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 depicts an example of a subject and a number of the subject's salivary glands;

FIG. 2 depicts an example of one or more stimulation sites on one or more portions of skin of the subject depicted in FIG. 1, where the one or more stimulation sites correspond to one or more salivary glands of the subject;

FIGS. 3 and 4 depict different views of an embodiment of a device worn by a subject and configured to stimulate saliva production, in accordance with embodiments disclosed herein;

FIG. 5 depicts the embodiment of the device shown in FIGS. 3 and 4 with the device removed from the subject, in accordance with embodiments disclosed herein;

FIGS. 6 and 7 depict embodiments of systems with end effectors removably couplable to appliances and configured to deliver vibratory stimuli to a subject, in accordance with embodiments disclosed herein;

FIG. 8 depicts, in block diagrammatic form, an example of operating structure of the appliances depicted in FIGS. 6 and 7, in accordance with embodiments disclosed herein;

FIG. 9 depicts an embodiment of a sensor device that is configured to be held within a mouth of a subject, in accordance with embodiments disclosed herein;

FIG. 10 depicts an embodiment of a system with a sensor device and a collar that communicate wirelessly, in accordance with embodiments disclosed herein;

FIG. 11 depicts an embodiment of a system with a sensor device and a collar that communicate via a wired connection, in accordance with embodiments disclosed herein; and

FIG. 12 depicts an embodiment of a method of stimulating saliva production in a subject, in accordance with embodiments disclosed herein.

### DETAILED DESCRIPTION

Various forms of energy input into biological organisms have different effects on the biological organisms. These forms of energy input include mechanical inputs, thermal inputs, electromagnetic inputs, electrical inputs, acoustic inputs, and the like.

One particular field of study, known as mechanobiology, aims to understand how physical forces and changes in cell or tissue mechanics affect biological organisms.

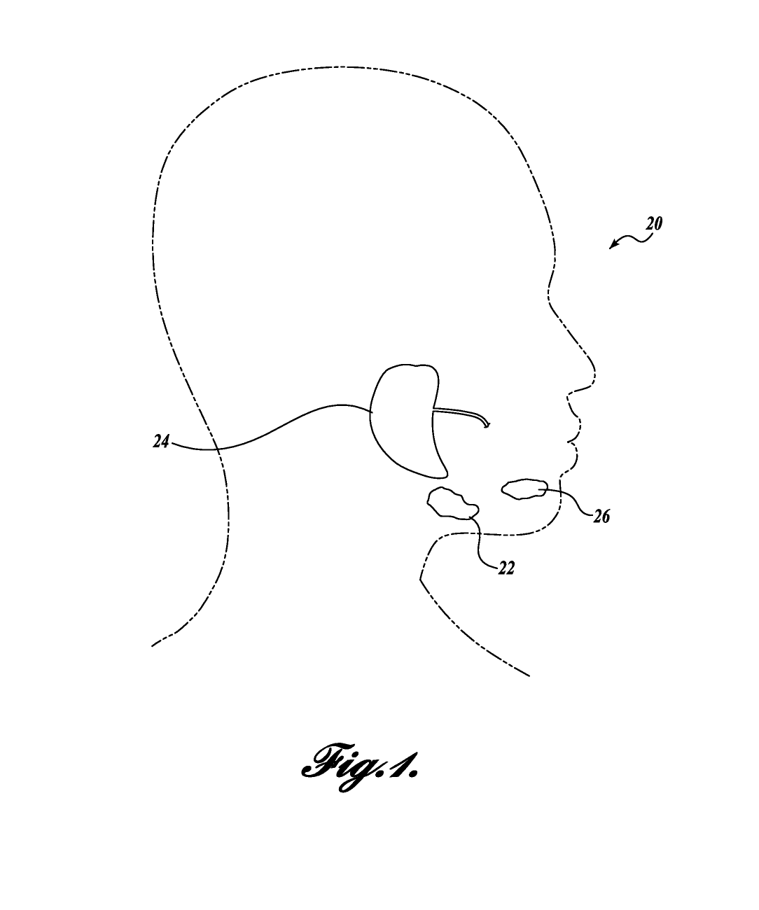

Under certain conditions, mechanical stimuli (e.g., applied cyclical strain, mechanical motion, applied strain, and the like) input to a portion of skin of a biological organism cause an increase in biomarker (e.g., protein) production. In one example, as depicted in FIG. 1, a subject 20 has a number of salivary glands, including submandibular glands, parotid glands, and sublingual glands. While the depiction in FIG. 1 shows the right side of the subject 20, including a right submandibular gland 22, a right parotid gland 24, and a right sublingual gland 26, the subject 20 also has a left submandibular gland, a left parotid gland, and a left sublingual gland that are not depicted in FIG. 1. Under certain conditions, the salivary glands stimulate saliva production in the mouth of the subject 20. In one example, the salivary glands of the subject 20 are stimulated to stimulate saliva production by a stimulus by, among other things, mechanical vibration applied at particular frequencies using an end effector or a contact point.

In one example, stimulation of saliva production can be used as a treatment for xerostomia (dry mouth). Xerostomia generally describes a dryness in the mouth of a subject. Xerostomia can be caused in a number ways, such as from changes to saliva composition, from reduced salivary flow, from a side effect to medication, from advanced age, from breathing through the mouth for extended periods of time, from dehydration, and from other causes. The effects of xerostomia include oral dryness, impaired oral functions, and reduced oral health. For example, subject with xerostomia can have unpleasant oral dryness, difficulty eating and speaking, increased risk for oral infections, increased risk for tooth decay, and a number of other ill effects.

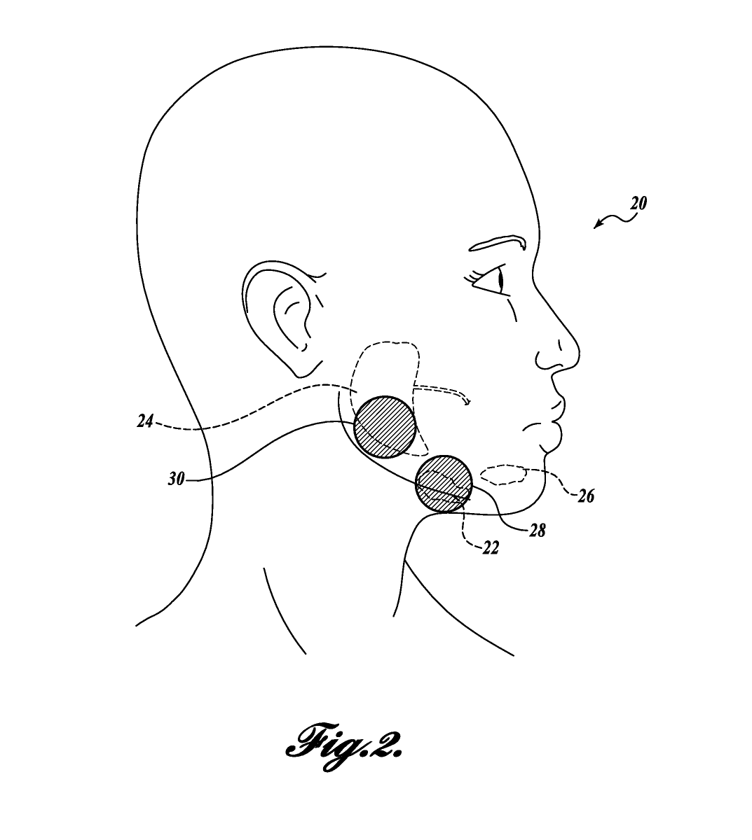

The disclosed embodiments employ technologies and methodologies that stimulate saliva production by one or more salivary glands. In an embodiment, as shown in FIG. 2, one or more stimulation sites 28 and 30 on one or more portions of skin of the subject 20 correspond to one or more salivary glands 22 and 24 of the subject 20. By introducing mechanical vibration at the one or more stimulation sites 28 and 30 at specific frequencies, the disclosed technologies and methodologies stimulate saliva production by one or more salivary glands, thereby addressing certain medical conditions, such as xerostomia. Depending on the particular location of the portion of skin in the subject 20, mechanical vibration generated in a range from about 60 Hz to about 120 Hz may stimulate saliva production by one or more salivary glands. In other embodiments, the mechanical vibrations generated are in a range from about 40 Hz to about 240 Hz to stimulate saliva production by one or more salivary glands.

The following discussion provides examples of systems, apparatuses, and methods for implementing technologies and methodologies for stimulating saliva production in subjects. In an embodiment, a device for stimulating saliva production in a subject includes a motor that vibrates a contact point at a stimulation frequency when the contact point is in contact with a portion of skin corresponding to a salivary gland. The vibration of the contact point produces a stimulus within the portion of skin that stimulates saliva production by the salivary glands. In an embodiment, a system for stimulating saliva production in a subject includes an appliance with a motor and an end effector configured to be placed against a stimulation site on a portion of skin of the subject corresponding to a salivary gland. The system is configured such that, when the motor is operating and the end effector is placed against the stimulation site, the stimulation frequency produces a stimulus within the portion of skin that stimulates saliva production by the salivary gland of the subject. In an embodiment, a method of stimulating saliva production in a subject includes placing a contact point against a stimulation site on a portion of skin of the subject and activating a motor coupled to the contact point such that the contact point vibrates at a stimulation frequency. The vibration of the contact point at the stimulation frequency produces a stimulus within the portion of skin of the subject that stimulates saliva production by the salivary gland of the subject.

In the following description, numerous specific details are set forth in order to provide a thorough understanding of one or more embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

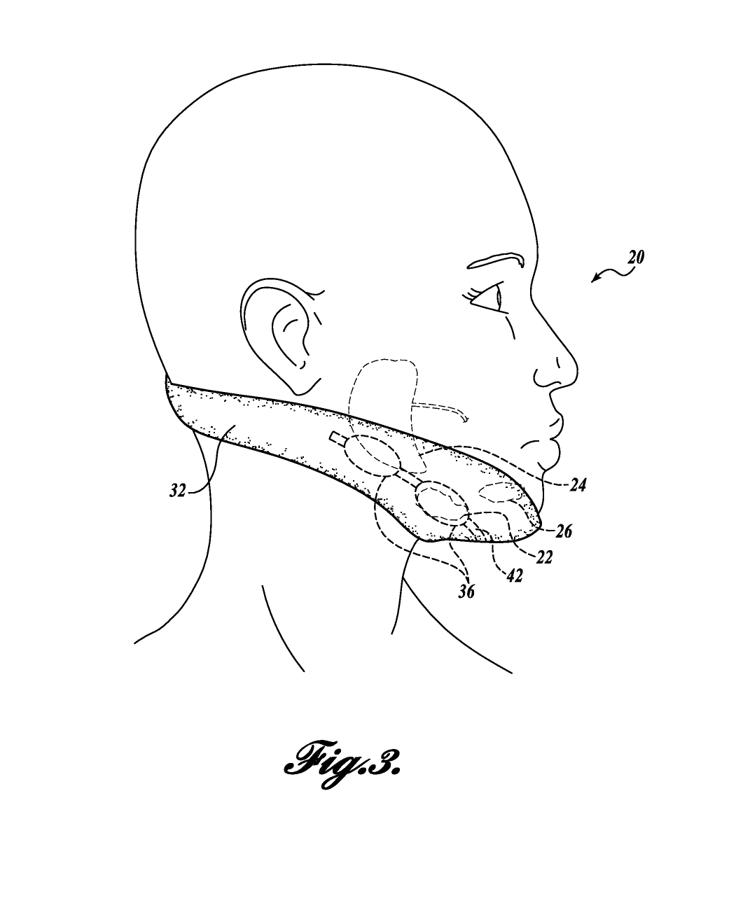

Depicted in FIGS. 3 to 5 is an embodiment of a device for stimulating saliva production in a subject in the form of a collar 32 that can be worn by a subject 20. Contact points 36 are located on an inner side 38 of the collar 32. The collar 32 is configured to hold the contact points 36 against stimulation sites on portions of skin of the subject 20. In some embodiments, the collar 32 comprises one or more flexible materials, such as cotton, wool, silk, nylon, polyester, neoprene, elastane, silicone rubber, and the like. In some embodiments, the material of the collar 32 is suitable to transfer energy from vibrations into portions of skin of the subject 20 and, ultimately, to one or more of the salivary glands 22 and 24. The collar 32 also includes connection mechanisms 40 that allow the collar 32 to be held around the neck of the subject 20 with the inner side 38 of the collar 32 toward the neck of the subject 20. In some embodiments, the connection mechanisms 40 include snaps, hook and loop mechanisms, a button and a button hole, or any other releasable connection mechanisms.

In the depicted embodiment, the contact points 36 are raised, convex pads. In one example, the pads are formed from rubber, silicone, plastic, or any other material. In one example, a hardness of the pads is selected based on an expected level of sensitivity of the subject 20. In one example, the hardness of the pads is in a range from about 10 Shore A to about 60 Shore A. In other examples, the hardness of the pads is in a range defined by the Rockwell hardness scale. The contact points 36 can also take other forms that are configured to contact the stimulation sites on the skin of the subject 20. In the depicted embodiment, the contact points 36 are coupled to a structural member 42. In one example, the structural member 42 is a rigid member that holds the contact points 36 in particular locations. In another example, the structural member 42 is a bendable member, such as copper wiring, that can be bent to particular formations. In the case where structural member 42 is a bendable member, the contact points 36 are adjustable based on the anatomy of the subject 20 (e.g., based on a location of the salivary glands of the subject 20). For example, in the depicted embodiment, the collar 32 is configured to hold the contact points 36 against portions of skin of the subject 20 under the chin of the subject 20 and behind the jaw of the subject 20. In one example, the contact points 36 are positioned against portions of skin of the subject 20 corresponding to a right submandibular gland of the subject 20, a left submandibular gland of the subject 20, a right parotid gland of the subject 20, or a left parotid gland of the subject 20. In one embodiment, the contact points 36 and the structural member 42 form a saliva stimulation assembly that is configured to elicit a salivary response by delivery of a vibratory stimulus.

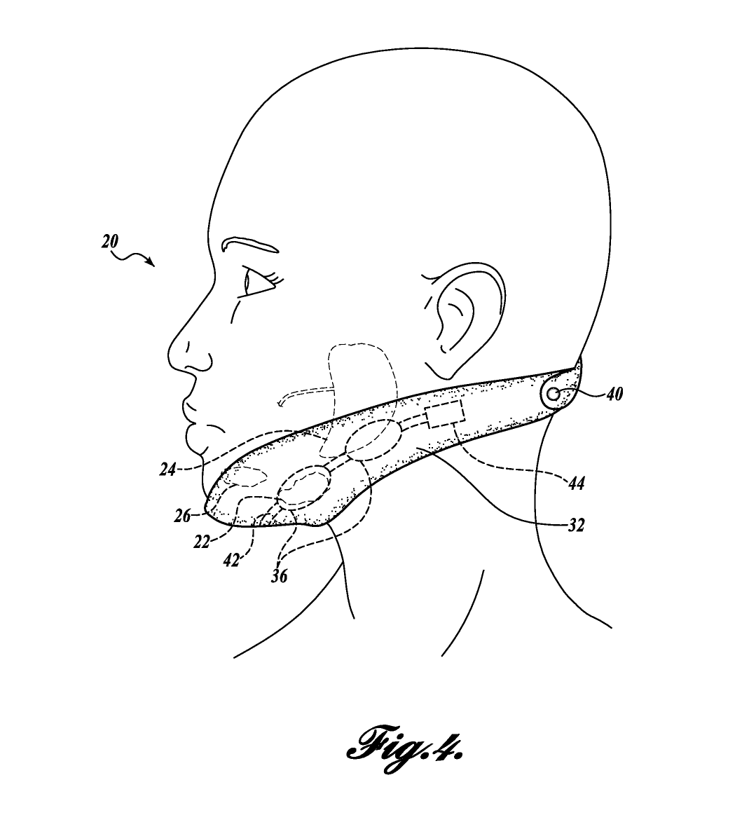

The collar 32 also includes a source of vibratory motion 44 that is coupled to the contact points 36. In some examples, the source of vibratory motion 44 includes a driven motor, a resonant motor, a wobble weight vibration applicator, a pneumatic oscillatory device, acoustic device (e.g., a speaker emitting acoustic waves within a range of particular frequencies), or any other device that generates vibratory motion. In one example, the source of vibratory motion 44 provides either resonant vibratory motion or non-resonant vibratory motion. In the particular embodiment depicted in FIG. 5, the source of vibratory motion 44 is coupled to the contact points 36 via the structural member 42. In other embodiments, the source of vibratory motion 44 is directly coupled to the contact points 36 or coupled to the contact points 36 via another member or mechanism. In another embodiment, the collar 32 includes multiple sources of vibratory motion, such as one source of vibratory motion coupled to each of the contact points 36. The source of vibratory motion 44 is configured to operate such that the contact points 36 vibrate at a stimulation frequency. In some embodiment, the stimulation frequency is in a range from about 60 Hz to about 120 Hz, in a range from about 70 Hz to about 80 Hz, or about 75 Hz. In other embodiments, the stimulation frequency is in a range from about 40 Hz to about 240 Hz. In other embodiments, vibrations in a burst or slew of frequencies are used to determine the stimulation frequency. In other embodiments, a feedback device senses saliva stimulation responses to different frequencies to determine the stimulation frequency based on an effectiveness of the different frequencies.

The vibration of the contact points 36 at the stimulation frequency produces a stimulus. The stimulus is transmitted via the portions of skin of the subject 20 to one or more salivary glands of the subject 20 to stimulate saliva production by the one or more salivary glands of the subject 20. In some embodiments, the stimulus is transmitted via the portions of skin and other tissue, such as muscle tissue, fat tissue, and the like, to reach the one or more salivary glands of the subject 20. In one embodiment, the stimulation frequency is selected such that the stimulus transmitted to the salivary glands of the subject 20 stimulates saliva production by the salivary glands of the subject 20.

In some embodiments, the collar 32 includes other features that aid in the stimulation of saliva production by the salivary glands of the subject 20. In one example, the collar 32 includes a power source 46, such as a rechargeable battery, configured to provide power to the source of vibratory motion 44. In another example, the collar 32 includes a controller 48 configured to control operation of the source of vibratory motion 44. As discussed in greater detail below, in one example, the controller 48 is configured to control operation of the source of vibratory motion 44 based on a sensed level of moisture within the mouth of the subject. In another example, the controller 48 is configured to control operation of the source of vibratory motion 44 by disengaging the motor after a predetermined amount of time of continuous operation of the source of vibratory motion 44. By disengaging the source of vibratory motion 44 after a predetermined amount of time of continuous operation of the source of vibratory motion 44, the controller 48 prevents the source of vibratory motion 44 from overly stimulating saliva production by the salivary glands of the subject 20.

In some instances, cases of xerostomia are more pronounced while a subject sleeps. The embodiment of the collar 32 depicted in FIGS. 3 to 5 is designed to be placed around the neck of the user. In one embodiment, the collar 32 is sized such that the subject 20 is capable of wearing the collar 32 while sleeping. If worn while the subject 20 is sleeping, operation of the collar 32 may stimulate saliva production while the subject 20 is sleeping to reduce or avoid the effects of xerostomia that the subject 20 experiences while sleeping.

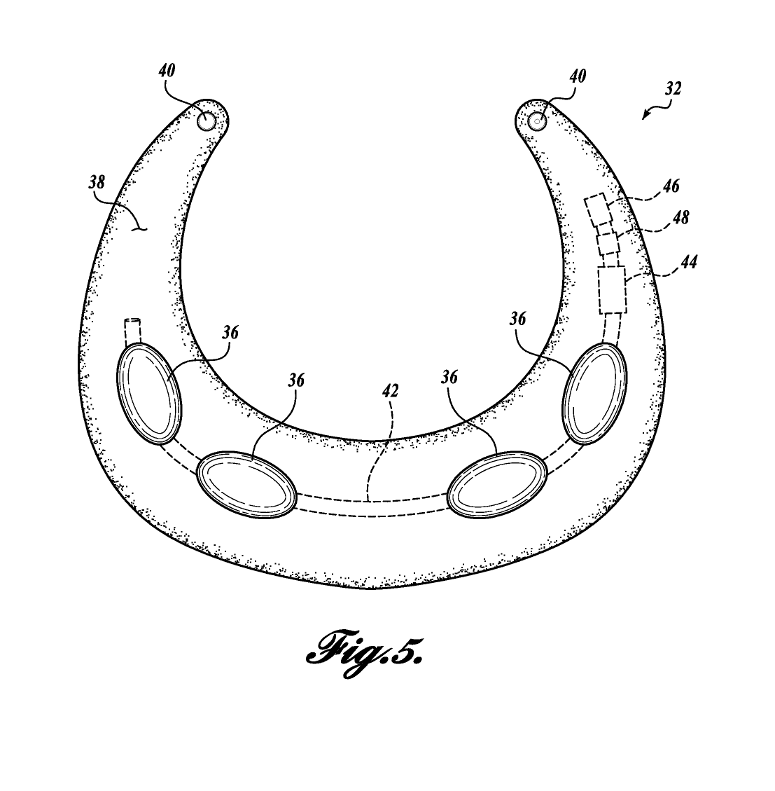

In other embodiments, stimulation of salivary glands of a subject is accomplished using end effectors that are removably couplable to an appliance. Embodiments of end effectors described herein are usable in a system, such as the embodiments of a system 100 depicted in FIGS. 6 and 7. The system 100 includes an appliance 102 and an end effector 104. The appliance 102 depicted in FIG. 6 is in the form of a handle; however, the appliance 102 can take any number of other forms, such as the form of a hand-held appliance depicted in FIG. 7. The appliance 102 includes a drive hub 106. The appliance 102 includes a motor (not shown) that is operatively coupled to the drive hub 106 such that operation of the motor causes movement of the drive hub 106. The appliance 102 includes one or more user input mechanisms 108. In one embodiment, operation of the motor is based on user inputs received by the one or more user input mechanisms 108. In some examples, user input received by the one or more user input mechanisms 108 cause one or more of initiating operation of the motor, changing an operating characteristic of the motor, and ceasing operation of the motor.

In an embodiment, the end effector 104 depicted in FIG. 6 includes an end portion 110 and a base portion 116. The end portion 110 includes a plurality of contact points 112. In one embodiment, the plurality of contact points 112 are located a distance from each other based on an inverse of a stimulation frequency. Placement of a plurality of contact points based on a stimulation frequency is described in greater detail in U.S. patent application Ser. No. 14/587,587, the contents of which are hereby incorporated by reference in their entirety. Each of the plurality of contact points 112 is located on one of a plurality of contact areas 114. The base portion 116 is coupled to the end portion 110 via a central support 118. The base portion includes a drive assembly 120 that is configured to engage the drive hub 106 of the appliance 102.

In an embodiment, the end effector 104 is physically couplable to the appliance 102. When the end effector 104 is coupled to the appliance 102, the drive assembly 120 of the end effector 104 is engaged to the drive hub 106 of the appliance 102 such that operation of the motor of the appliance 102 causes movement of the drive hub 106 that is transferred to the drive assembly 120 of the end effector 104 to move the end effector. In one embodiment, operation of the motor imparts oscillating movement to the end effector 104 with an amount of inertia to move the end effector 104 at a target frequency and amplitude. In one example, the motor is configured to drive the end effector 104 at a frequency in a range from about 60 Hz to about 120 Hz. In another example, the motor is configured to drive the end effector 104 at an angular amplitude in a range from about 2° to about 10° of peak-to-peak motion. Such oscillating movement of the end effector 104 causes vibration of the end effector 104. When the end effector 104 is applied to a portion of skin, a stimulus is produced within the portion of skin at about the stimulation frequency. In some examples, the oscillating frequency is about the stimulation frequency. In other examples, the oscillating frequency is different from the stimulation frequency. In one example, the stimulus is a cyclical mechanical strain at the stimulation frequency.

In one embodiment, the end effector 104 is usable interchangeably with both embodiments of the appliance 102 depicted in FIGS. 6 and 7. In other words, in this particular example, the drive assembly 120 of end effector 104 is separately engagable with both the drive hub 106 of the appliance 102 depicted in FIG. 6 and the drive hub 106 of the appliance 102 depicted in FIG. 7. In one embodiment, the appliance 102 depicted in FIG. 6 and the appliance 102 depicted in FIG. 7 have different characteristics, such as different motor sizes, different motor inertias, etc. In such a case, the system 100 depicted in FIG. 6 has a different stimulation frequency than the system 100 depicted in FIG. 7. Because of the difference in resonance frequencies with different combinations of end effectors and appliances, in some embodiments, end effectors are designed (such as by selecting a particular mass of the end effectors) to operate with specific appliances and/or motors to have a target resonance frequency.

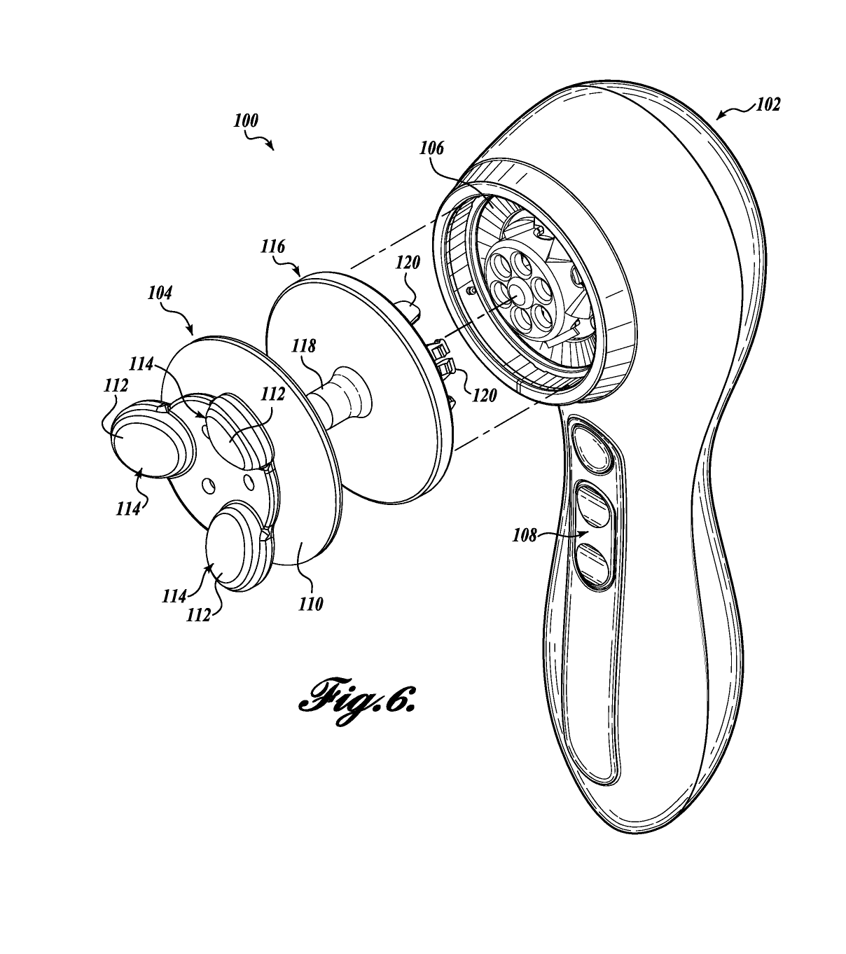

FIG. 8 depicts, in block diagrammatic form, an example of operating structure of the appliance 102. Other embodiments of appliances described herein, such the embodiments of collars described here, include, in some examples, an operating structure such as the operating structure shown in FIG. 8. In one embodiment, appliance 102 includes a drive motor assembly 122, a power storage source 130, such as a rechargeable battery, and a drive control 128. In one example, the drive control 128 is coupled to or includes one or more user interface mechanisms (e.g., the one or more user interface mechanisms 108). The drive control 128 is configured and arranged to selectively deliver power from the power storage source 130 to the drive motor assembly 122. In an embodiment, the drive control 128 includes a power adjust or mode control buttons coupled to control circuitry, such as a programmed microcontroller or processor, which is configured to control the delivery of power to the drive motor assembly 122. In one embodiment, the drive motor assembly 122 includes an electric drive motor 124 (or simply motor 124) that drives an attached head, such as an end effector, via a drive gear assembly. In other embodiments, the appliance 102 includes another source of vibratory motion, such as a wobble weight vibration applicator, a pneumatic oscillatory device, or an acoustic device, in place of the motor 124.

In one embodiment, when an end effector is coupled to the appliance 102 (e.g., such as when end effector 104 is coupled to appliance 102), the drive motor assembly 122 is configured to impart oscillatory motion to the end effector in a first rotational direction and a second rotational direction. In one embodiment, the drive motor assembly 122 includes a drive shaft 126 (also referred to as a mounting arm) that is configured to transfer oscillatory motion to a drive hub 106 of the appliance 102. In one example, the appliance 102 is configured to oscillate the end effector at sonic frequencies. In an embodiment, the appliance 102 oscillates the end effector at frequencies from about 60 Hz to about 120 Hz. One example of a drive motor assembly 122 that may be employed by the appliance 102 to oscillate the end effector is shown and described in U.S. Pat. No. 7,786,646, which is incorporated herein by reference. However, it should be understood that this is merely an example of the structure and operation of one such appliance and that the structure, operation frequency and oscillation amplitude of such an appliance could be varied, depending in part on its intended application and/or characteristics of the applicator head, such as its inertial properties, etc. In an embodiment of the present disclosure, the frequency ranges are selected so as to drive the end effector at near resonance. Thus, selected frequency ranges are dependent, in part, on the inertial properties of the attached head. It will be appreciated that driving the attached head at near resonance provides many benefits, including the ability to drive the attached head at suitable amplitudes in loaded conditions (e.g., when contacting the skin). For a more detailed discussion on the design parameters of the appliance, please see U.S. Pat. No. 7,786,646.

In one embodiment, the system 100 depicted in FIG. 6 is operated with the appliance 102 oscillating the end effector 104 at a frequency of 75 Hz at an oscillation amplitude of 9-10 degrees. The end effector 104 is applied to the neck of a subject under the jaw in areas of the parotid and submandibular glands for 30 seconds on each of the left and right side of the subject's neck. A subject may experience greater saliva flow during operation of the appliance 102 with the oscillating the end effector 104 in contact with the subject's neck. After the appliance 102 is disabled and/or the end effector 104 is removed from the subject's neck, the subject may also experience greater saliva flow for some time. In other embodiments, the system 100 is operated at a resonance frequency in a range between about 70 Hz and about 120 Hz. In another embodiment, the system 100 is operated at a resonance frequency in a range between about 70 Hz and about 80 Hz.

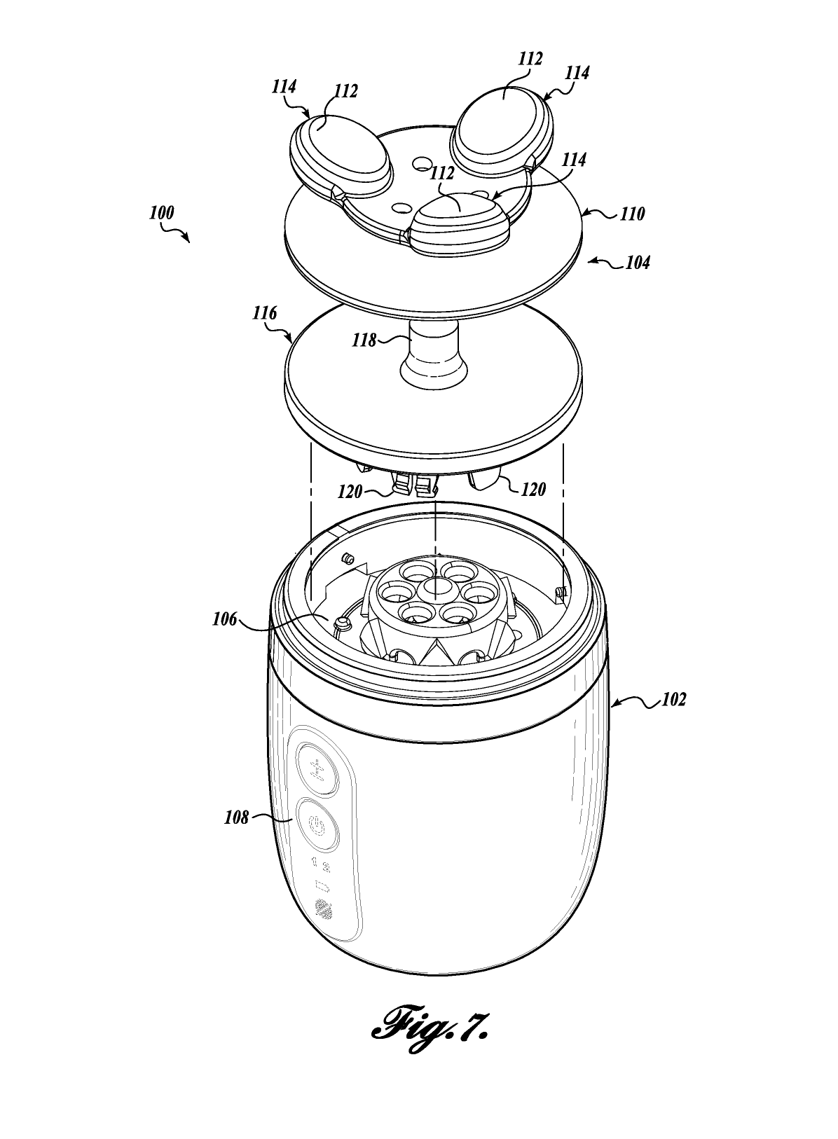

FIG. 9 depicts an embodiment of a sensor device 200 that is configured to be held within a mouth of a subject. The sensor device 200 includes a structure 202 that holds various components of the sensor device 200. In the particular embodiment shown in FIG. 9, the structure 202 is arranged such that the sensor device 200 is in the form of a mouth guard. Such a form may be advantageous because it is a known form factor that subjects can wear while sleeping.

The sensor device 200 also includes moisture sensors 204 that are configured to generate a signal indicative of moisture within the mouth of the subject. In the embodiment, the moisture sensors 204 include eight moisture sensors with four moisture sensors on the right side of the sensor device 200 and four moisture sensors on the left side of the sensor device 200. In other embodiments, any other number of moisture sensors 204 including one or more moisture sensors. As described in more detail below, in some embodiments, the signals generated by the moisture sensors 204 are used to control operation of a motor coupled to one or more contact points to control stimulation of the salivary glands of a subject by the motor and the one or more contact points.

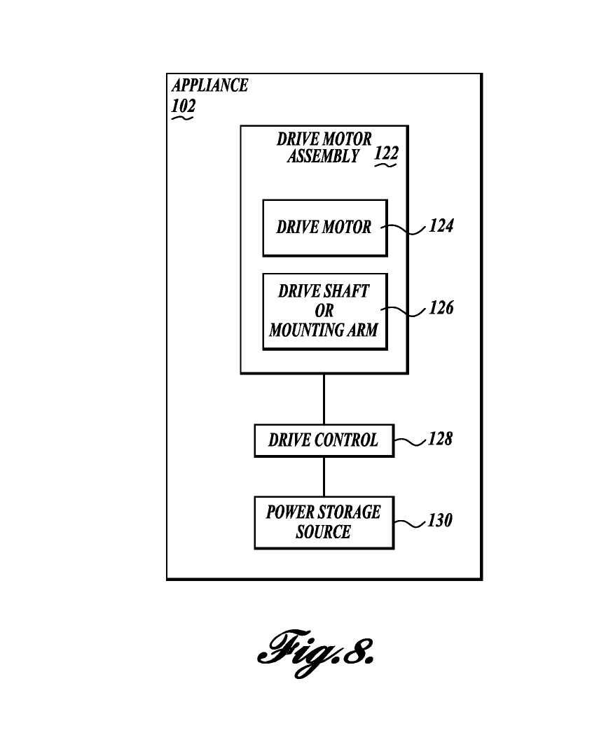

An embodiment of a system with the sensor device 200 and a collar 212 is depicted in FIG. 10. The collar 212 includes contact points 214 that are capable of being vibrated by a motor (not shown) in the collar 212 to produce a stimulus within a portion of skin of a subject that stimulates saliva production by the a salivary gland of the subject. The sensor device 200 includes a wireless transmitter 206 configured to transmit a wireless signal 218. The collar 212 includes a wireless receiver 216 configured to receive the wireless signal 218. In one example, the wireless signal 218 is a short range wireless communication signal, such as a Bluetooth signal, a near field communication signal, a ZigBee signal, and the like. In one embodiment, the wireless signal 218 includes the signal indicative of moisture within the mouth of the subject generated by the moisture sensors 204. In one embodiment, the collar 212 includes a controller (not shown) configured to control operation of the motor based on the signal indicative of moisture within the mouth of the subject generated by the moisture sensors 204 received via the wireless signal 218 from the sensor device 200.

The embodiment of the sensor device 200 depicted in FIG. 10 also includes circuitry 208 and a rechargeable battery 210 on anterior ends of the structure 202. In one example, the circuitry 208 is configured to process the signal indicative of moisture within the mouth of the subject generated by the moisture sensors 204 for transmission via the wireless signal 218. The rechargeable battery 210 is configured to provide power to components in the sensor device 200, such as the wireless transmitter 206. In one example, placement of the circuitry 208 and the rechargeable battery 210 on the anterior ends of the structure 202 may avoid contact of the circuitry 208 and the rechargeable battery 210 with the subject's teeth and/or tongue.

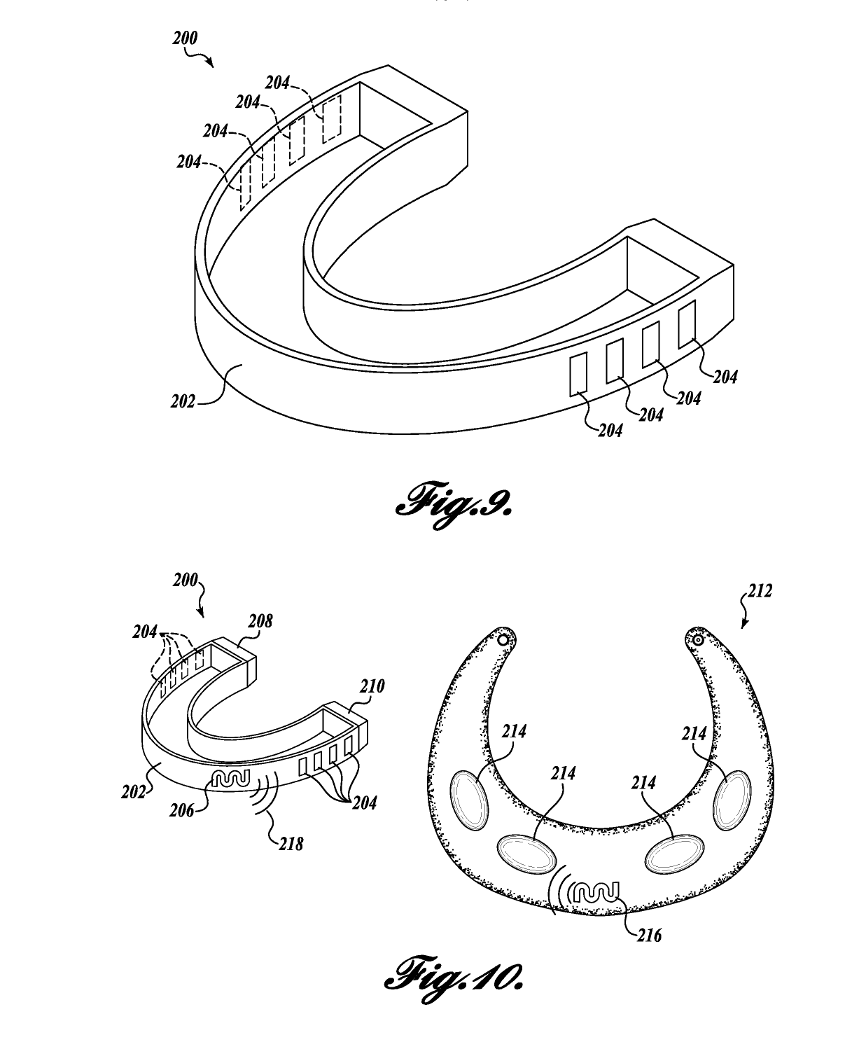

Another embodiment of a system with the sensor device 200 and a collar 212 is depicted in FIG. 11. In this embodiment, the sensor device 200 is coupled to the collar via a cable 220. In one embodiment, the cable 220 includes leads configured to carry, from the sensor device 200 to the collar 212, the signal indicative of moisture within the mouth of the subject generated by the moisture sensors 204. In one embodiment, the collar 212 includes a controller (not shown) configured to control operation of the motor (not shown) based on the signal indicative of moisture within the mouth of the subject generated by the moisture sensors 204 received via the cable 220 from the sensor device 200. In another embodiment, the cable 220 includes leads that provide power from the collar 212 to the sensor device 200 to power the moisture sensors 204.

In one example, both of systems depicted in FIGS. 10 and 11 are usable by a subject while the subject sleeps. While the subject sleeps, the sensor device 200 sends the signal indicative of moisture within the mouth of the subject generated by the moisture sensors 204 to the collar 212 either wirelessly (as shown in FIG. 10) or wired (as shown in FIG. 11). The collar 212 stimulates saliva production by the subject's salivary glands based on the signal indicative of moisture within the mouth of the subject.

In other examples, the embodiments of the sensor device 200 depicted in FIGS. 10 and 11 are usable with other motored devices, such as the embodiments of appliances 102 depicted herein. In other examples, the sensor device 200 is usable with non-motored devices, such as a health monitor. For example, the sensor device 200 sends a signal either wirelessly (similar to the depiction in FIG. 10) or wired (similar to the depiction in FIG. 11) to a vital signs monitor that is configured to issue a notification when the levels of moisture within the patient's mouth are below a threshold. The notification allows health care workers, such as nurses or other attendants, to address the level of moisture within the patient's mouth.

As depicted in FIGS. 9 to 11, the sensor device 200 can include an array of moisture sensors 204. In one embodiment, the signal indicative of moisture within the mouth of the subject generated by the moisture sensors 204 includes indications of moisture at each of the moisture sensors 204. In one embodiment, a controller or other device takes into account the indications of moisture at each of the moisture sensors 204 to control stimulation of saliva production. In one example, stimulation of saliva production may not be initiated until a certain percentage of the moisture sensors 204 indicate a low moisture condition. In another example, stimulation of saliva production may be initiated on one side of the subject's neck in response to the moisture sensors 204 on the same side indicating a low moisture condition. The stimulation of saliva production can be controlled based on any number of other combinations of indications of moisture at each of the moisture sensors 204.

The devices described herein, including the collar 32 depicted in FIGS. 3 to 5, the system 100 depicted in FIG. 6, and the system 100 depicted in FIG. 7 are capable of being used in methods of stimulating saliva production in subjects. In one embodiment, a method includes delivering a vibratory stimulus to one or more stimulation sites associated with one or more salivary glands of a subject via one or more contact points and varying an average power of an electro-mechanical vibratory motion assembly coupled to the one or more contact points such that the one or more contact points vibrate at a stimulation frequency of a character and for a duration sufficient to elicit a salivary response by delivery of a vibratory stimulus. Variations of this method and other embodiments of methods described herein are capable of being performed by the embodiments of devices and systems describe herein.

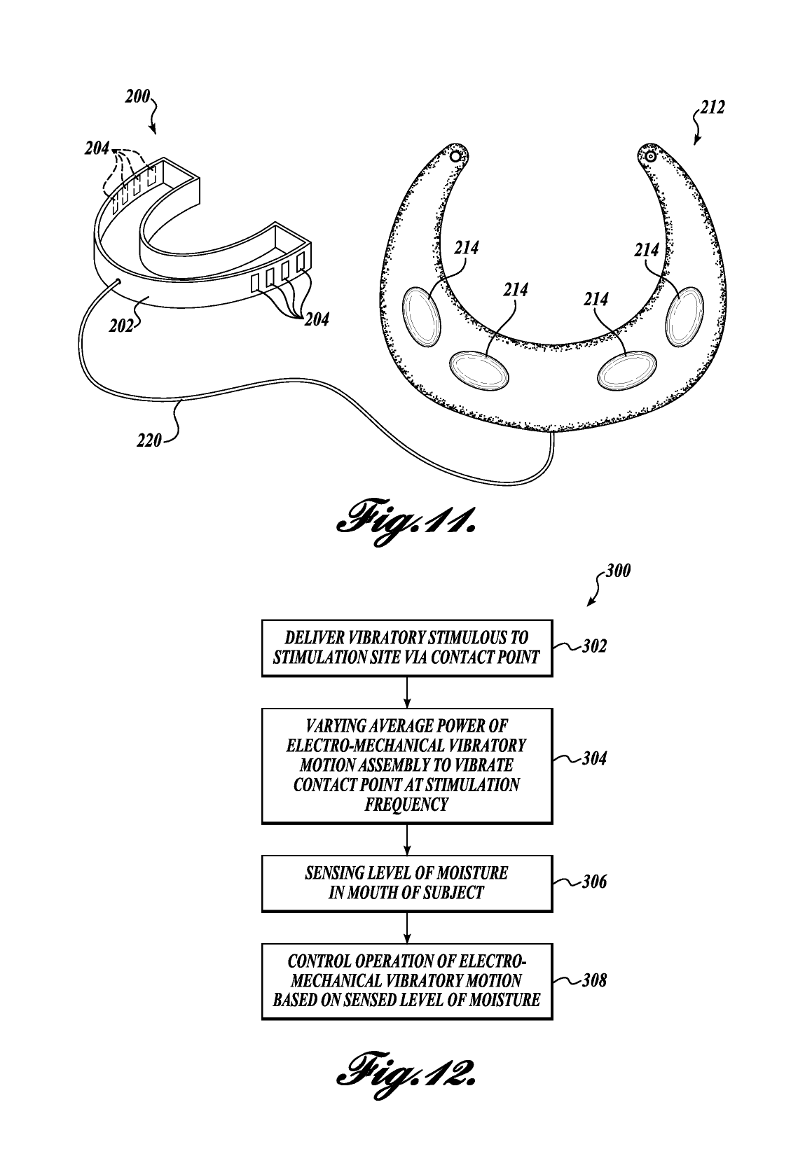

FIG. 12 depicts an embodiment of a method 300 of stimulating saliva production in a subject. At block 302, a vibratory stimulus is delivered to a stimulation site of a subject via a contact point. In one embodiment, the stimulation site is associated with a salivary gland of the subject.

At block 304, an average power of an electro-mechanical vibratory motion assembly coupled to the contact point is varied such that the contact point vibrates at a stimulation frequency. In one example, the average power of the electro-mechanical vibratory motion assembly is related to the mechanism or mechanisms used to couple and transfer vibratory stimulation from the electro-mechanical vibratory motion assembly. In another example, the average power of the electro-mechanical vibratory motion assembly is determined such that the power into one or more salivary glands does not exceed the stimulation of a desired result. In some embodiments, the electro-mechanical vibratory motion assembly includes a driven motor, a resonant motor, a wobble weight vibration applicator, a pneumatic oscillatory device, acoustic device, or any other device that generates vibratory motion. In one embodiment, the stimulation frequency is of a character and for a duration sufficient to elicit a salivary response by delivery of a vibratory stimulus. In one example, the duration is about 30 seconds. In some embodiments, the duration of stimulation is repeated after a time of no stimulation. In another example, the duration is less than or equal to 60 seconds. In another example, the duration is based on a desired amount of saliva stimulation to address a particular condition (e.g., alleviating the feeling of dry mouth, providing saliva for mastication of food, etc.). In some examples, the particular condition is specified by a user (e.g., a subject, a medical care provider, etc.) into a control device and the control device controls operation of the electro-mechanical vibratory motion assembly. In another embodiment, when the contact point is placed against stimulation site and the electro-mechanical vibratory motion assembly is activated to produce the vibratory stimulus, the vibration of the contact point at the stimulation frequency produces a stimulus that is transmitted via at least one portion of skin of the subject to the salivary gland of the subject to elicit the salivary response.

In one embodiment, the method 300 also includes, at block 306, sensing a level of moisture within a mouth of the subject. In some embodiments, the moisture within the mouth of the subject is sensed using an intraoral sensor, such as a sensor in the form of a mouth guard, as disclosed herein. In some embodiments, the intraoral sensor is configured to transmit wired or wireless signals indicative of the sensed level of moisture within the mouth of the subject. At block 308, operation of the electro-mechanical vibratory motion assembly is controlled based on the sensed level of moisture within the mouth of the subject. In some embodiments, controlling the electro-mechanical vibratory motion assembly includes one or more of starting the electro-mechanical vibratory motion assembly, stopping the electro-mechanical vibratory motion assembly, reducing power of the electro-mechanical vibratory motion assembly, increasing power of the electro-mechanical vibratory motion assembly, or any other operation to control the electro-mechanical vibratory motion assembly. In another embodiment, delivering the vibratory stimulus to the one or more stimulation sites includes placing a collar that includes the one or more contact points around a neck of the subject.

It should be noted that for purposes of this disclosure, terminology such as “upper,” “lower,” “vertical,” “horizontal,” “inwardly,” “outwardly,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A device for stimulating saliva production in a subject, the device comprising:
a source of vibratory motion; and
a saliva stimulation assembly configured to elicit a salivary response by delivery of a vibratory stimulus, the saliva stimulation assembly including one or more contact points coupled to the source of vibratory motion and configured to be placed against one or more stimulation sites on one or more portions of skin of the subject corresponding to one or more salivary glands of the subject;
wherein the source of vibratory motion is configured such that, when the source of vibratory motion is operating, the one or more contact points vibrate at a stimulation frequency; and
wherein, when the source of vibratory motion is operating and the one or more contact points are placed against the stimulation site, the vibration of the one or more contact points at the stimulation frequency produces a stimulus that is transmitted via the at least one portion of skin of the subject to the one or more salivary glands of the subject to stimulate saliva production by the one or more salivary glands of the subject.

2. The device of claim 1, further comprising:
a collar configured to hold the one or more contact points against the one or more portions of skin of the subject corresponding to the one or more salivary glands of the subject.

3. The device of claim 2, wherein the collar is adjustable such that a position of the one or more contact points is adjustable based on a location of the one or more salivary glands of the subject.

4. The device of claim 2, wherein the collar is configured to hold the one or more contact points against the one or more portions of skin of the subject corresponding to one or more of a right submandibular gland of the subject, a left submandibular gland of the subject, a right parotid gland of the subject, or a left parotid gland of the subject.

5. The device of claim 1, further comprising:
a controller configured to control operation of the source of vibratory motion.

6. The device of claim 5, wherein the controller is configured to control operation of the source of vibratory motion based on a sensed level of moisture within the mouth of the subject.

7. The device of claim 5, wherein the controller is configured to control operation of the source of vibratory motion by disengaging the source of vibratory motion after a predetermined amount of time of continuous operation of the source of vibratory motion.

8. The device of claim 1, wherein the stimulation frequency is in a range from about 70 Hz to about 80 Hz.

9. The device of claim 1, wherein the one or more contact points includes three or fewer contact points.

10. A system for stimulating saliva production in a subject, the system comprising:
an appliance having a source of vibratory motion; and
an end effector operably coupled to the appliance, wherein the end effector is configured to be placed against one or more stimulation sites on one or more portions of skin of the subject corresponding to one or more salivary glands of the subject;
wherein the source of vibratory motion is configured to move the end effector such that, when the source of vibratory motion is operating, the system has a stimulation frequency; and
wherein the system is configured such that, when the source of vibratory motion is operating and the end effector is placed against the one or more stimulation sites, the stimulation frequency is configured to produce a stimulus that is transmitted via the at least one portion of skin of the subject to the one or more salivary glands of the subject to stimulate saliva production by the one or more salivary glands of the subject.

11. The system of claim 10, further comprising:
a sensor device configured to be held within a mouth of the subject, wherein the sensor device includes one or more moisture sensors configured to generate a signal indicative of moisture within the mouth of the subject.

12. The system of claim 11, wherein the sensor device is in the form of a mouth guard.

13. The system of claim 11, wherein the sensor device further includes a wireless transmitter configured to transmit, to a wireless receiver coupled to the source of vibratory motion, the signal indicative of moisture within the mouth of the subject.

14. The system of claim 13, wherein the system is configured to adjust operation of the source of vibratory motion based on the signal indicative of moisture within the mouth of the subject.

15. The system of claim 10, wherein the stimulation site is located under the chin of the subject and behind the jaw of the user.

16. The system of claim 10, wherein the one or more salivary glands of the subject comprise one or more of a right submandibular gland of the subject, a left submandibular gland of the subject, a right parotid gland of the subject, or a left parotid gland of the subject.

17. The system of claim 10, wherein the end effector is removably coupled to the appliance.

18. A method of stimulating saliva production in a subject, the method comprising:
delivering a vibratory stimulus to one or more stimulation sites associated with one or more salivary glands of a subject via one or more contact points; and
varying an average power of an electro-mechanical vibratory motion assembly coupled to the one or more contact points such that the one or more contact points vibrate at a stimulation frequency of a character and for a duration sufficient to elicit a salivary response by delivery of a vibratory stimulus.

19. The method of claim 18, wherein, when the one or more contact points are placed against one or more stimulation sites and the electro-mechanical vibratory motion assembly is activated to produce the vibratory stimulus, the vibration of the one or more contact points at the stimulation frequency produces a stimulus that is transmitted via at least one portion of skin of the subject to the one or more salivary glands of the subject to elicit the salivary response.

20. The method of claim 18, wherein delivering the vibratory stimulus to the one or more stimulation sites includes placing a collar that includes the one or more contact points around a neck of the subject.

21. The method of claim 18, further comprising:
sensing a level of moisture within a mouth of the subject.

22. The method of claim 21, further comprising:
controlling operation of the electro-mechanical vibratory motion assembly based on the sensed level of moisture within the mouth of the subject.
